(19) United States
(12) Patent Application Publication
(10) Pub. No.: US 2007/0093262 A1
(43) Pub. Date: Apr. 26, 2007

(54) Transmitting data on an uplink associated with multiple mobile stations in a spread spectrum cellular system

(76) Inventors: Shupeng Li, Middlesex, NJ (US); Sudhir Ramakrishna, New York, NY (US); Ashok Narasimhaiya Rudrapatna, Somerset, NJ (US)

Correspondence Address: WILLIAMS, MORGAN & AMERSON, 10333 RICHMOND, SUITE 1100, HOUSTON, TX, 77042, US

(21) Appl. No.: 11/256,630

(22) Filed: Oct. 21, 2005

(51) Int. Cl. H04M 1/00

(52) U.S. Cl. 455/552.1

(57) ABSTRACT

The present invention provides a method and an apparatus for transmitting data on an uplink by selectively using multiple access modes to multiplex a transmission based on at least two different transmit formats. A method of wireless communication between at least one mobile station and a base station sector in a cellular system enables a first transmit format for a first transmission of the at least one mobile station on an uplink to the base station sector to multiplex first and second components of the first transmission based on a first access mode. The method further comprises enabling a second transmit format different than the first transmit format for a second transmission on the uplink from the at least one mobile station to multiplex first and second components of the second transmission based on a second access mode. In a spread spectrum cellular system, a base station sector may assign some transmission slots for a non-orthogonal transmission and other transmission slots for an orthogonal transmission to at least one mobile station, for example, in an uplink transmission. At the same time, for example, a base station sector may assign both modes to different mobile stations during the same time slot. By selectively using time and frequency or code division multiplexing, the mobile station may reduce interference, or alternatively, introduce minimal interference associated with multiple mobile stations transmitting data simultaneously at a base station sector. The reduced interference may enhance aggregate throughput of the uplink.

### 1. FIELD OF THE INVENTION

This invention relates generally to telecommunications, and more particularly, to wireless communications.

### 2. DESCRIPTION OF THE RELATED ART

Wireless communications systems or mobile telecommunication systems typically provide different types of services to various users or subscribers of wireless communication devices. The wireless communication devices may be mobile or fixed units and situated within a geographic region across one or more wireless networks. The users or subscribers of wireless communication devices, such as mobile stations (MSs) or access terminals or user equipment may constantly move within (and outside) particular wireless networks.

A wireless communications system generally includes one or more base stations (BSs) that can establish wireless communications links with mobile stations. Base stations may also be referred to as node-Bs or access networks. To form the wireless communications link between a mobile station and a base station, the mobile station accesses a list of available channels/carriers broadcast by the base station. To this end, a wireless communications system, such as a spread spectrum wireless communications system, may allow multiple users to transmit simultaneously within the same wideband radio channel, enabling a frequency re-use based on a spread spectrum technique.

Many cellular systems, for example, spread-spectrum cellular systems use a Code division multiple access (CDMA) protocol to transmit data in a wireless network consistent with a desired standard, such as IS-95, CDMA2000 or Universal Mobile Telecommunication System (UMTS) based wideband-CDMA (WCDMA). A spread-spectrum cellular system generally provides transmissions associated with one or more mobile stations that a base station may be serving on the downlink (a.k.a. forward (FL) link). As such, transmissions from mobile stations to a single sector (base station) may occur on the uplink (a.k.a. reverse (RL) link).

For establishing a wireless communication in a cellular system, a base station (BS) schedules the transmissions of the various mobile stations (MSs) that it is serving on the MS-to-BS (reverse link, RL). To this end, the base station may send commands to the mobile stations on the BS-to-MS link (forward link, FL). For example, in a particular cellular system, the mobile stations may use time units based radio access commonly referred to as time slots to transmit on the reverse (RL) link to the base station. The time slots are usually quasi-synchronized (e.g., approximately at the slot boundaries) across the mobile stations (MSs) and the base station (BSs).

Likewise, on the reverse link (RL), one or more mobile stations may communicate with a serving base station, for example, in two transmission modes. That is, when communicating on the reverse link, if transmissions to the serving base station from a particular subset of mobile stations interfere with each other at the base station then the mobile stations may be in a first transmission mode called a non-orthogonal mode. For example, use of a CDMA or a multi-carrier CDMA (MC-CDMA) protocol for radio access by the subset of mobile stations to communicate on the reverse link may cause the subset of mobile stations to be in the first transmission mode. In this case, the transmissions to the serving base station from the subset of mobile stations occur on the same frequency bandwidth while utilizing non-orthogonal codes. As a result, the transmissions can not be orthogonal to each other, and thus interfere with each other at the base station. When a mobile station transmits in the non-orthogonal mode, this situation may apply to either pilot (used for demodulation or for SINR estimation) or for bearer/traffic channels or to both channels.

However, if the transmissions from a subset of mobile stations on the reverse link are such that they do not interfere with each other at the serving base station, the subset of mobile stations are characterized as being in a second transmission mode. In the second transmission mode, this subset of mobile stations is referred to as an orthogonal mode. For example, such an orthogonal mode may result for a subset of mobile stations when the subset of mobile stations communicates on the reverse link using Orthogonal Frequency Division Multiplexing (OFDM) as the radio access technique. In this case, the transmissions from the subset of mobile stations being served by a base station occur on different radio frequencies and are orthogonal to one another. Consequently, the transmissions in the second transmission mode do not interfere with each other at the base station. Again, as is the situation in the non-orthogonal mode, this scenario may apply to either pilot or for bearer/traffic channels or to both channels when a mobile station is transmitting in the orthogonal mode. By sending one or more messages on the forward link, a base station (BS) may control the mobile station transmissions in two control modes.

While operating in a MC-CDMA mode, different types of spreading techniques, such as spreading in the frequency domain may be used by mobile stations (MSs). However, when mobile stations in a cellular system use the MC-CDMA mode on the MS-to-BS (reverse link, RL) link transmission.

In a cellular system, the mobile stations (MSs) may use a variety of different access techniques for enabling the MS-to-BS (reverse link, RL) link transmission. Using different access techniques, multiple mobile stations may transmit data signals to a base station sector. These multiple mobile stations may be located within a same cell sector associated with a base station. However, data bits transmitted at the same time by multiple mobile stations generally cause significant interference between the data signals received at the base station. Thus, use of multiple access techniques on the reverse link results in interference that significantly degrades the system performance of the cellular system. For example, an unacceptable level of data packet transmission may severely affect the aggregate throughput on the reverse link.

### SUMMARY OF THE INVENTION

The following presents a simplified summary of the invention in order to provide a basic understanding of some aspects of the invention. This summary is not an exhaustive overview of the invention. It is not intended to identify key or critical elements of the invention or to delineate the scope of the invention. Its sole purpose is to present some concepts in a simplified form as a prelude to the more detailed description that is discussed later.

The present invention is directed to overcoming, or at least reducing, the effects of, one or more of the problems set forth above.

In one embodiment of the present invention, a method is provided for a wireless communication between at least one mobile station and a base station sector in a cellular system. The method comprises enabling a first transmit format for a first transmission of the at least one mobile station on to the base station sector to multiplex first and second components of the first transmission based on a first access mode. The method further comprises enabling a second transmit format different than the first transmit format for a second transmission from the at least one mobile station to multiplex first and second components of the second transmission based on a second access mode.

In another embodiment of the present invention, a method is provided for a wireless communication between a base station and at least one mobile station in a cellular system. The method comprises assigning to the at least one mobile station one or more first transmission slots for use by a first access mode that enables a non-orthogonal transmit format and one or more second transmission slots for use by a second access mode that enables an orthogonal transmit format.

In yet another embodiment of the present invention, a frame format is provided for enabling a wireless communication between at least one mobile station and a base station sector in a cellular system. The frame format comprises a first transmit format for a first transmission of the at least one mobile station on an uplink to the base station sector to multiplex the first transmission based on a first access mode. The frame format further comprises a second transmit format different than the first transmit format for a second transmission on the uplink from the at least one mobile station to multiplex the second transmission based on a second access mode.

### BRIEF DESCRIPTION OF THE DRAWINGS

The invention may be understood by reference to the following description taken in conjunction with the accompanying drawings, in which like reference numerals identify like elements, and in which:

FIG. 1 schematically depicts a spread-spectrum cellular system to include a set of base stations each associated with one or more cell sectors and a plurality of mobile stations that may be capable of using multiple access modes for multiplexing a transmission based on at least two different transmit formats according to one illustrative embodiment of the present invention;

FIG. 2 schematically depicts a frame format that enables two different transmit formats for a first and a second transmission of the mobile station on the uplink to a base station sector for multiplexing a transmission based on multiple access modes in accordance with one illustrative embodiment of the present invention;

FIG. 3 depicts a stylized representation for implementing a method of transmitting data on the uplink associated with multiple mobile stations in the spread-spectrum cellular system shown in FIG. 1 based on the frame format shown in FIG. 2, consistent with one exemplary embodiment of the present invention;

FIG. 4 depicts a stylized representation for implementing a method of transmitting data in an orthogonal and/or non-orthogonal transmit format on the uplink in response to a command in a downlink, in accordance with one illustrative embodiment of the present invention; and

FIG. 5 illustrates a stylized representation for implementing a method of selectively using at least one of a first and a second access mode to multiplex a pilot and a data portion of a transmission to provide a non-orthogonal or an orthogonal transmission in accordance with one illustrative embodiment of the present invention.

While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed, but on the contrary, the intention is to cover all modifications, equivalents, and alternatives falling within the spirit and scope of the invention as defined by the appended claims.

### DETAILED DESCRIPTION OF SPECIFIC EMBODIMENTS

Illustrative embodiments of the invention are described below. In the interest of clarity, not all features of an actual implementation are described in this specification. It will of course be appreciated that in the development of any such actual embodiment, numerous implementation-specific decisions may be made to achieve the developers' specific goals, such as compliance with system-related and business-related constraints, which will vary from one implementation to another. Moreover, it should be appreciated that such a development effort might be complex and time-consuming, but may nevertheless be a routine undertaking for those of ordinary skill in the art having the benefit of this disclosure.

Generally, a method and an apparatus are provided for transmitting data on an uplink by selectively using multiple access modes to multiplex a transmission based on at least two different transmit formats. A method of wireless communication between at least one mobile station and a base station sector in a cellular system enables a first transmit format for a first transmission of the at least one mobile station on an uplink to the base station sector to multiplex first and second components of the first transmission based on a first access mode. The method further comprises enabling a second transmit format different than the first transmit format for a second transmission on the uplink from the at least one mobile station to multiplex first and second components of the second transmission based on a second access mode. During the same slots, in which the multiple mobile stations may be transmitting in the uplink, however, different mobile stations may use different transmission formats. In a spread spectrum cellular system, a base station sector may assign to at least one mobile station one or more first transmission slots for use by a first access mode, e.g., multi-carrier code division multiple access (MC-CDMA) that enables a non-orthogonal transmit format and one or more second transmission slots for use by a second access mode, e.g., orthogonal frequency division multiplexing access (OFDMA) that enables an orthogonal transmit format. In response to a command in a downlink, a mobile station may transmit data in an orthogonal and/or non-orthogonal transmit format on the uplink using at least tow carriers. By selectively using time and frequency or code division multiplexing, the mobile station may reduce interference, or alternatively, introduce minimal interference associated with multiple mobile stations transmitting data simultaneously at a base station sector. The reduced interference may enhance aggregate throughput of the uplink.

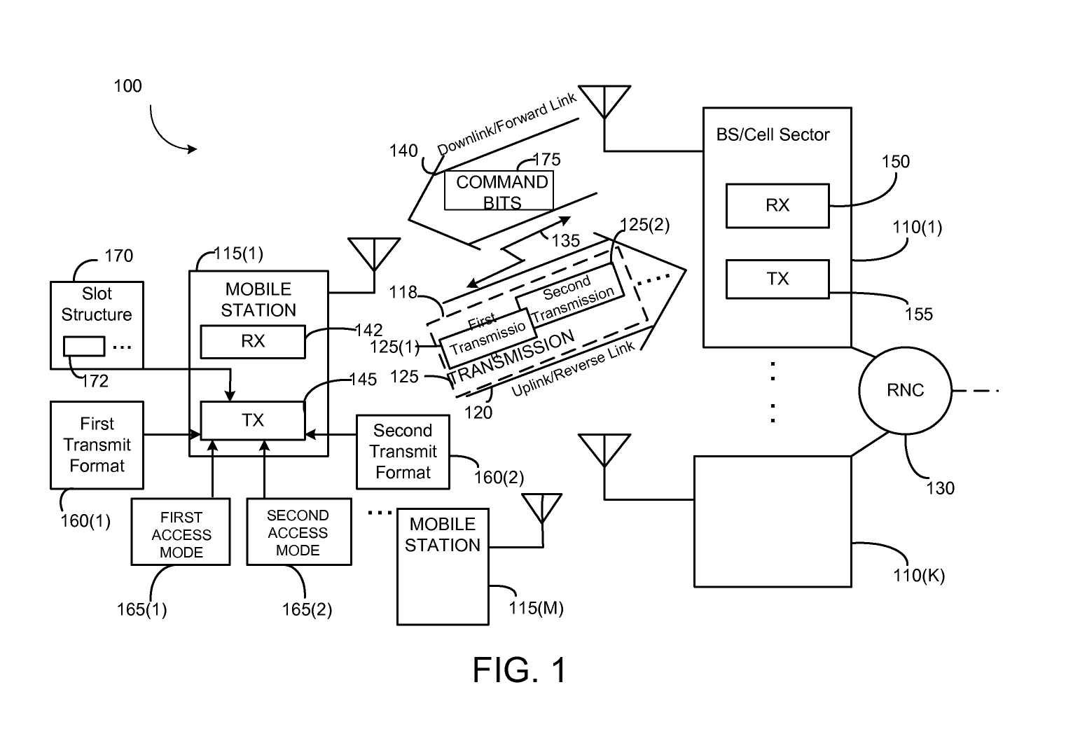

Referring to FIG. 1, a spread-spectrum cellular system 100 is illustrated to include a set of base stations (BSs) 110 (1-k) each associated with one or more cell sectors and a plurality of mobile stations (MSs) 115 (1-m) that may be capable of using multiple access modes for multiplexing a transmission 125 based on at least two different transmit formats according to one illustrative embodiment of the present invention. At least one mobile station 115(1) may transmit data on the uplink 120 using at least tow carriers to a base station associated with a cell sector, i.e., a base station sector 110(1). The set of base stations 110 (1-k) may provide the wireless connectivity to the mobile station 115 (1) according to any desirable protocol. Examples of a protocol include a code division multiple access (CDMA, CDMA2000) protocol, a multi-carrier CDMA (MC-CDMA), an orthogonal frequency division multiplexing access (OFDMA) protocol, a wideband-CDMA (WCDMA) protocol, a Universal Mobile Telecommunication System (UMTS) protocol, a Global System for Mobile communications (GSM) protocol, and like.

Examples of the mobile stations 115 (1-m) may include a host of wireless communication devices including, but not limited to, cellular telephones, personal digital assistants (PDAs), and global positioning systems (GPS) that employ the spread spectrum cellular system 100 to operate in a high-speed wireless data network, such as a digital cellular CDMA network. Other examples of the mobile stations 115 (1-m) may include smart phones, text messaging devices, and the like.

In the spread-spectrum cellular system 100, mobile communications that communicate messages between the set of base stations 110 (1-k) and each mobile stations 115 (1-m) may occur over an air interface via a wireless channel 135, such as a radio frequency (RF) medium channel that uses a code division multiple access (CDMA) protocol. Although not shown, the wireless channel 135 may include any intermediate devices that facilitate wireless communication between the mobile stations 115 (1-m) and the set of base stations 110 (1-k). For example, the wireless channel 135 may use a variety of repeaters, antennas, routers, and any desirable communication or network component capable of providing wireless communication. Each mobile station 115 (1-m) may further communicate with the set of base stations 110 (1-k) using the uplink (reverse link) 120 over the wireless channel 135.

A radio network controller 130 may coordinate a handover of mobile communications upon a user leaving an area of responsibility of one base station 110(1), into another base station 110(k). That is, a handover of mobile communications occurs for the mobile station 115(1) when responsibility of communication switches from a first cell sector served by the base station sector 110(1) to a second cell sector served by another base station sector 110(k).

According to one illustrative embodiment of the present invention, the spread-spectrum cellular system 100 may include a frame selector unit (FSU) connected to both the base stations, comparing the frames received by the base station sectors 110(1) and 110(k) to identify the better frame. This makes it possible for two (or more) base stations of the set of base stations 110(1-k) to seamlessly support the mobile stations 115(1-m).

To communicate with different base stations 110(1-k), the mobile station 115(1) may comprise a receiver (RX) 142 and a transmitter (TX) 145. While the receiver 142 may receive transmissions of packet data from the set of base stations 110(1-k), the transmitter 145 may transmit packet data in transmission 125. The transmission 125 may comprise packet data to the base station sector 110(1).

The base station sector 110(1) may comprise a receiver (RX) 150 and a transmitter (TX) 155 in one embodiment of the present invention. While the receiver 150 may receive transmissions of packet data from the mobile stations 115(1-m), the transmitter 155 may transmit packet data and signaling messages when the base station 110(1) may serve the mobile station 115(1) on the uplink 120. In one embodiment, the mobile station 115(1) may use a code division multiple access (CDMA) protocol, or a multi-carrier CDMA (MC-CDMA) radio access technique to communicate on the uplink 120.

The mobile station 115(1) may transmit data on the uplink 120 by selectively using multiple access modes in combination with different transmit formats in the spread spectrum wireless cellular system 100, consistent with one embodiment of the present invention. For example, the transmitter 145 may use at least two carriers in a transmission 125 on the uplink 120 to the base station sector 110(1). One example of such use of multiple carriers in the spread-spectrum cellular system 100 includes a multi-carrier/code division multiple access (MC-CDMA) protocol.

For transmitting data on the uplink 120 from the mobile station 115(1) to a base station associated with a cell sector, i.e., a base station sector 110(1), the transmitter 145 may enable a first transmit format 160(1) and a second transmit format 160(2). The transmitter 145 may provide the second transmit format 160(2) different than the first transmit format 160(1). That is, to multiplex a transmission (TX) 125, for the mobile station 115(1) the transmitter 145 may provide multiple access modes including a first access mode 165(1) and a second access mode 165(2). For the mobile station 115(1), the first transmit format 160(1) may enable multiplexing of a first transmission 125(1) on the uplink 120 based on the first access mode 165(1). Likewise, the second transmit format 160(2) may enable multiplexing of a second transmission 125(2) on the uplink 120 based on the second access mode 165(2).

By using time and frequency or code division multiplexing, the mobile station 115(1) may select a mode of transmission between the first access mode 165(1) and the second access mode 165(2). For enabling a desired multiplexing of a transmission 125 in the uplink 120, the mobile station 115(1) may determine a particular transmission format among the first transmit format 160(1) and the second transmit format 160(2).

The transmitter 145 may separate first and second transmissions 125(1,2) (which may be associated with the same user or different users) in time, frequency, spatial domains, or a combination thereof. For a same user, the transmitter 145 may selectively use the first access mode 165(1) to multiplex a pilot and a data portion of the first transmission 125(1) or the second access mode 165(2) to multiplex a pilot and a data portion of the second transmission 125(2) on the uplink 120. For different users, the transmitter 145 may enable multiplexing of the first transmission 125(1) from the mobile station 115(1) based on the first or second access modes 165(1,2) with the second transmission 125(2) from the mobile station 115(m) based on the first or second access modes 165(1,2).

In one embodiment, the mobile station 115(1) may use a multi-carrier code division multiple access (MC-CDMA) protocol for the first access mode 165(1). For the second access mode 165(2), the transmitter 145 of the mobile station 115(1) may deploy an orthogonal frequency division multiple access (OFDMA) protocol to multiplex the second transmission 125(2).

Based on the first transmit format 160(1) for the first access mode 165(1), in one embodiment, the transmitter 145 may provide a non-orthogonal mode of transmission on the uplink 120 to the base station sector 110(1). Likewise, using the second transmit format 160(2) for the second access mode 165(2), the transmitter 145 of the mobile station 115(1) may provide an orthogonal mode of transmission on the uplink 120.

One example of the non-orthogonal mode of transmission may be based on multi-carrier code division multiplexing. Likewise, one example of an orthogonal mode of transmission is based on time and frequency division multiplexing, such as an orthogonal frequency division multiple access protocol (OFDMA). In the orthogonal mode of transmission, the mobile station 115(1) may avoid causing interference in the base station sector 110(1) to which multiple mobile stations 115(1-m) may be transmitting data bits at the same time. That is, in the orthogonal mode of transmission, the mobile station 115(1) may not cause intra-cell mutual interference between the signals received at the receiver 150 of the base station sector 110(1).

The transmitter 145 may define a criteria that is not associated with the base station sector 110(1) for the mobile station 115(1) such that the interference from the first and second access modes 165(1,2) at the base station sector 110(1) may remain below a given threshold for the interference. The transmitter 145 may use the criteria to cause the mobile station 115(1) to select a particular transmit format among the first and second transmit formats 160(1), 160(2). In other words, the mobile station 115(1) may select to transmit either in an orthogonal mode of transmission or in a non-orthogonal mode of transmission based on the criteria provided at the transmitter 145.

In one embodiment, different multiplexing schemes and transmission slot structures may be used by the mobile station 115(1) to transmit on the uplink 120 via which other mobile stations 115(2-m) may be transmitting at the same time. To provide an orthogonal mode of transmission and/or a non-orthogonal mode of transmission on the uplink 120 using time or division multiplexing in the spread-spectrum cellular system 100, the transmitter 145 of the mobile station 115(1) may enable a slot structure 170. The slot structure 170 may comprise a plurality of slots 172. On example of the slot structure 170 is based on use of frames in a channel for transmitting data from the mobile station 115(1) on the uplink 120 to the base station sector 110(1).

In this way, by selectively using time/frequency or code division multiplexing, the mobile station 115(1) may reduce interference, or alternatively, introduce minimal interference associated with multiple mobile stations transmitting data simultaneously at the base station sector 110(1). By minimizing interference, for example, the mobile station 115(1) may enhance aggregate throughput of the uplink 120.

Each mobile station 115 may transmit traffic packets, such as data packets in the transmissions 125. Often the traffic packets include information that is intended for a particular user of a mobile station 115. For example, traffic packets may include voice information, images, video, data requested from an Internet site, and the like. From the base station sector 110(1), the mobile station 115(1) may also receive configuration messages, setup instructions, switch instructions, handoff instructions, and the like.

In the spread spectrum cellular system 100, a wireless data network may deploy any desirable protocol to enable wireless communications between the base stations 110(1-k) and the mobile stations 115(1-m) according to any desirable protocol. Examples of such a protocol include a (CDMA, WCDMA) protocol, a UMTS protocol, a GSM protocol, and like. The radio network controller (RNC) 130 may be coupled to the base station sector 110(1) and 110(k) to enable a user of the mobile station 115(1) to communicate packet data over a network, such as a cellular network. One example of the cellular network includes a digital cellular network based on a CDMA protocol, such as specified by the 3rd Generation (3G) Partnership Project (3GPP) specifications.

Other examples of such a protocol include a WCMDA protocol, a UMTS protocol, a GSM protocol, and like. The radio network controller 130 may manage exchange of wireless communications between the mobile stations 115(1-m) and the base stations 110(1-k) according to one illustrative embodiment of the present invention. Although two base stations 110(1-k) and one radio network controller 130 are shown in FIG. 1, persons of ordinary skill in the pertinent art having benefit of the present disclosure should appreciate that any desirable number of base stations 110 and radio network controllers 130 may be used.

Each of the base stations 110(1-k), sometimes referred to as Node-Bs, may provide connectivity to associated geographical areas within a wireless data network. Persons of ordinary skill in the art should appreciate that portions of such a wireless data network may be suitably implemented in any number of ways to include other components using hardware, software, or a combination thereof. Wireless data networks are known to persons of ordinary skill in the art and so, in the interest of clarity, only those aspects of a wireless data network that are relevant to the present invention will be described herein.

According to one embodiment, each mobile station 115 may communicate with an active base station 110 on the uplink 120 via the radio network controller 130 coupled to the first and second base station sectors 110(1,k). Each mobile station 115 may communicate over the uplink 120 with the active base station, which is generally referred to as the serving base station or the serving sector. The 3rd Generation Partnership Project (3GPP2) standard defines the role of a serving base station or a serving sector and a serving radio network controller based on 3GPP2 specifications.

Consistent with one embodiment, the uplink 120 and the downlink 140 may be established on a plurality of channels. The channels, such as traffic and control channels may be associated with separate channel frequencies. For example, CDMA channels with associated channel number and frequency may form a wireless communication link for transmission of high-rate packet data. On the downlink 140, for example, the mobile stations 115(1-m) may update the base station 110(1) with a data rate to receive transmissions on a Forward Traffic Channel or a Forward Control Channel. The Traffic Channel carries user data packets. The Control Channel carries control messages, and it may also carry user traffic. The downlink 140 may use a Forward MAC Channel that includes four sub-channels including a Reverse Power Control (RPC) Channel, a Data Rate Control Lock (DRCLock) Channel, ACK channel and a Reverse Activity (RA) Channel.

On the uplink 120, the mobile station 115(1) may transmit on an Access Channel or a Traffic Channel. The Access Channel includes a Pilot Channel and a Data Channel. The Traffic Channel includes Pilot, MAC and Data Channels. The MAC Channel comprises four sub-channels including a Reverse Rate Indicator (RRI) sub-channel that is used to indicate whether the Data Channel is being transmitted on the Reverse Traffic Channel and the data rate. Another sub-channel is a Data Rate Control (DRC) that is used by the mobile station 115(1) to indicate to the first base station sector 110(1) a data rate that the Forward Traffic Channel may support on the best serving sector. An acknowledgement (ACK) sub-channel is used by the mobile station 115(1) to inform the base station sector 110(1) whether the data packet transmitted on the Forward Traffic Channel has been received successfully. A Data Source Control (DSC) sub-channel is used to indicate which of the base station sectors should be transmitting forward link data.

In another embodiment, the mobile station 115(1) may provide the transmission 125 of packet data, as shown in FIG. 1, to at least two cell sectors associated with one or more of a set of base stations 110(1-k). In one embodiment, the spread-spectrum cellular system 100 may be based on a cellular network, which at least in part, may be based on a Universal Mobile Telecommunications System (UMTS) standard. The cellular network may be related to any one of the 2G, 3G, or 4G standards that employ any one of the protocols including the UMTS, CDMA2000, or the like, however, use of a particular standard or a specific protocol is a matter of design choice and not necessarily material to the present invention.

According to one embodiment, a conventional Open Systems Interconnection (OSI) model may enable transmission of the packet data and other data including messages, packets, datagram, frames, and the like between the mobile station 115(1) and the set of base stations 110(1-k). The term “packet data” may include information or media content that has been arranged in a desired manner. The packet data may be transmitted as frames including, but not limited to, a radio link protocol (RLP) frame, signaling link protocol (SLP) frame or any other desired format. Examples of the packet data may include a payload data packet representative of voice, video, signaling, media content, or any other type of information based on a specific application.

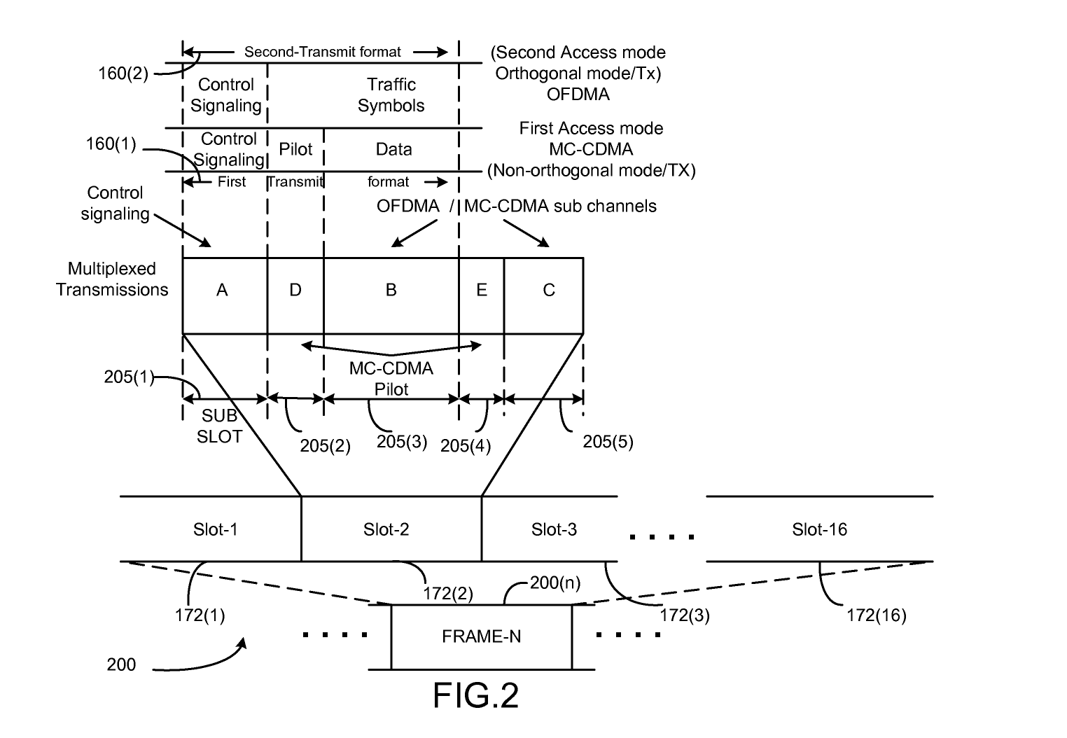

FIG. 2 schematically illustrates one embodiment a frame format 200 that enables two different transmit formats for the first and second transmissions 125(1,2) of the mobile station 115(1) on the uplink 120 to the base station sector 110(1) for multiplexing the transmission 125 based on multiple access modes. The frame format 200 may enable a wireless communication between at least one mobile station, such as the mobile station 115(1) and the base station sector 110(1) associated with a cell in the spread-spectrum cellular system 100 shown in FIG. 1. The frame format 200 may comprise the first transmit format 160(1) for providing the first transmission 125(1) associated with at least one mobile station 115(1). On the uplink 120 to the base station sector 110(1), the mobile station 115(1) may multiplex the first transmission 125(1) based on the first access mode 165(1). The frame format 200 may further comprise the second transmit format 160(2) different than the first transmit format 160(1). The second transmit format 160(2) may provide the second transmission 125(2) on the uplink 120 from the mobile station 115(1). By multiplexing the second transmission 125(2) based on the second access mode 165(2).

The first transmission 125(1) may include a pilot and a data portion, the transmitter 145 may multiplex the pilot and data portions using the first access mode 165(1). In this way, the mobile station 115(1) may provide a non-orthogonal transmission in the first transmit format 160(1) on the uplink 120. The second transmission 125(2) may also include a pilot and a data portion such that the pilot and data portions may be multiplexed on the uplink 120 using the second access mode 165(2) to provide an orthogonal transmission in the second transmit format 160(2).

The frame 200(n) may comprise a plurality of time slots 172(1-16) to transmit the pilot and data portions using multi-carrier code division multiplexing for the first access mode 165(1) and time and frequency division multiplexing for the second access mode 165(2). The transmitter 145 may separate the pilot and data portions of the first transmission 125(1) and the pilot and data portions of the second transmission 125(2) in temporal, spectral, and/or spatial domains in the uplink 120. Within a time slot 172(2), for example, to transmit the pilot and data portions of the first transmission 125(1) and that of the second transmission 125(2) in the temporal, spectral, and/or spatial domains, the transmitter 145 may use a plurality of time sub-slots 205(1-5) in the uplink 120. For the second transmission mode, transmission may be gated off during sub-slots D and E, i.e., 205(2) and 205(4).

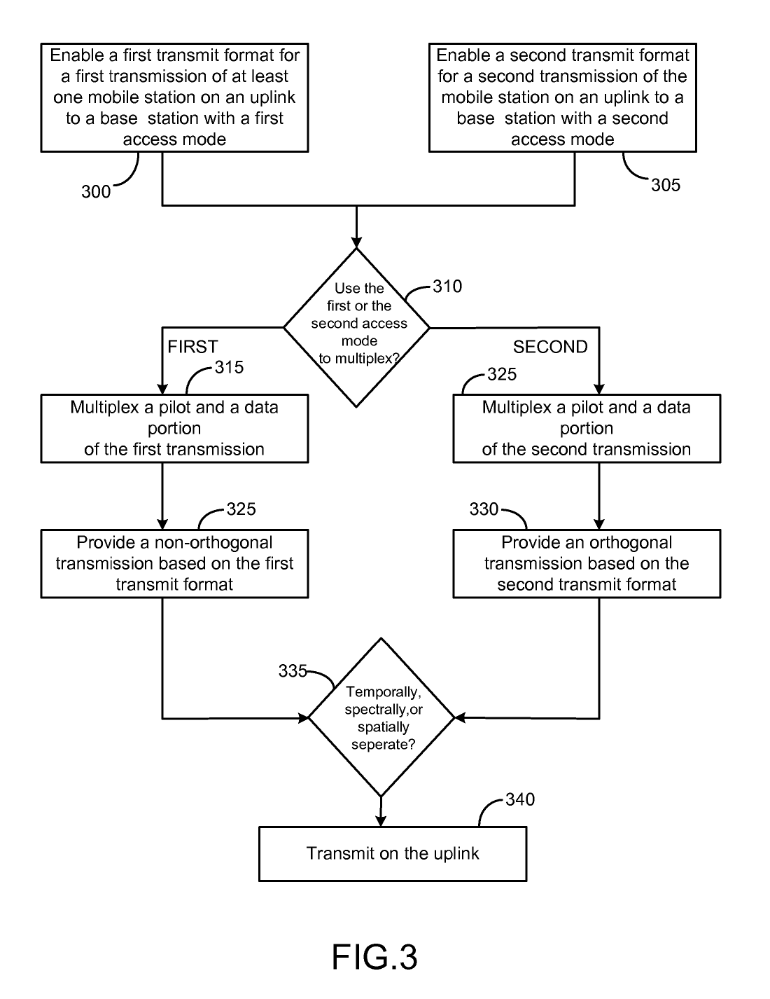

Consistent with one exemplary embodiment of the present invention, in FIG. 3, a stylized representation for implementing a method of transmitting data on the uplink 120 associated with the mobile stations 115(1-m) in the spread-spectrum cellular system 100 shown in FIG. 1 is depicted based on the frame format 200 shown in FIG. 2. At block 300, the transmitter 145 may enable the first transmit format 160(1) for the first transmission 125(1) on the uplink 120. Likewise, at block 305, the mobile station 115(1) may enable the second transmit format 160(2) for the second transmission 125(2) on the uplink 120.

A decision block 310 may determine whether to use the first or the second access mode 165(1,2) to multiplex the transmission 125 at the mobile station 115(1). If use of the first access mode 165(1) is selected by the mobile station 115(1), the transmitter 145 at block 315, may multiplex a pilot and a data portion of the first transmission 125(1). Otherwise, if use of the second access mode 165(2) is indicated in the decision block 310, a pilot and a data portion of the second transmission 125(2) may be multiplexed at block 320.

Using the first transmit format 160(1), at block 325, the transmitter 145, may provide a non-orthogonal transmission based on the first access mode 165(1). For the second access mode 165(2), the transmitter 145 may provide an orthogonal transmission using the second transmit format 160(2), as shown in block 330. A decision block 335 may indicate whether to separate the non-orthogonal and orthogonal transmissions temporarily, spectrally, or spatially. Based on a type of separation indicated for the orthogonal and non-orthogonal transmissions in the decision block 335, at block 340, the transmitter 145 may transmit the first transmission 125(1) and the second transmission 125(2) on the uplink 120.

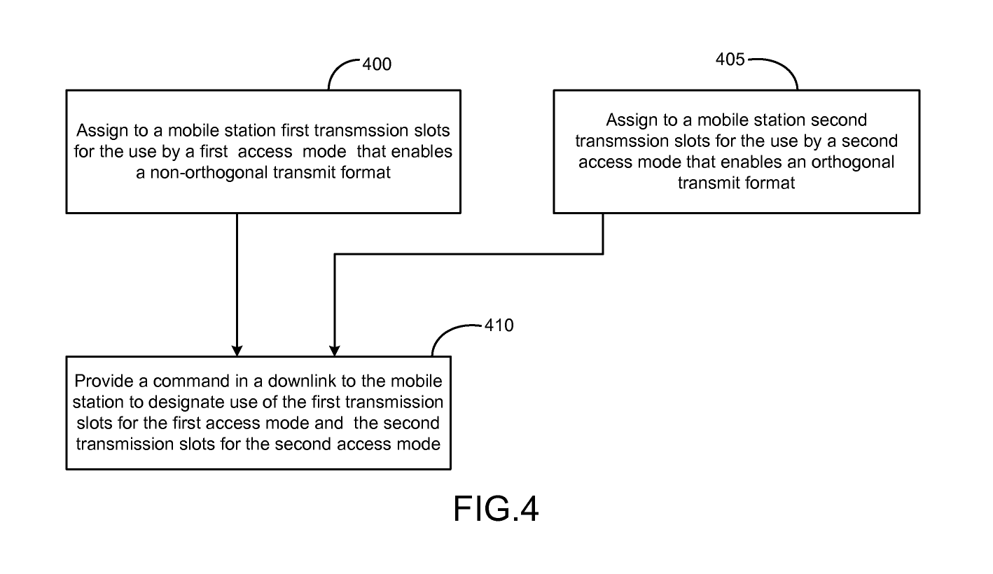

Turning now to FIG. 4, a stylized representation for implementing a method of transmitting data in an orthogonal and/or non-orthogonal mode of transmission is depicted on the uplink 120 in response to the command 175 in the downlink, 140 in accordance with one illustrative embodiment of the present invention. At block 400, the base station sector 110(1) may assign one or more first transmission slots within the slot structure 170 for use by the first access mode 165(1), which enables a non-orthogonal transmit format, i.e., the first transmit format 160(1). To enable an orthogonal transmit format, i.e., the second transmit format 160(2), the base station sector 110(1) may assign one or more second transmission slots within the slot structure 170 for use by the second access mode 165(2), as shown in block 405.

For the purposes of assigning the first and second transmission slots in the slot structure 170, the base station sector 110(1) may provide a command 175 in a downlink (a.k.a. forward link) 140, as indicated at block 410. The command 175 may indicate use of each of the one or more first transmission slots only for the first access mode 165(1) and use of each of the one or more second transmission slots only for the second access mode 165(2). One example of the command 175 includes command bits that indicate use of the orthogonal and/or non-orthogonal transmit formats within the second transmission slots.

The receiver 150 of a base station associated with a cell sector, such as the base station sector 110(1) may determine whether the mobile station 115(1) is using the first or second or both access mode 165(1), 165(2). If use of the first access mode 165(1) is indicated, the receiver 150 of the base station sector 110(1) may receive control signaling in a first sub-slot, and a pilot portion along with a data portion in a second sub-slot. Otherwise, if the mobile station 115(1) indicates that the second access mode 165(2) is selected for the second transmission 125(2) on the uplink 120, the receiver 150 may receive control signaling and one or more traffic symbols in an entire timeslot 172. In this manner, the slot structure 170 may enable use of multiplexing based on the first and second access modes 165(1,2) for populating the first and second transmission slots on the uplink 120.

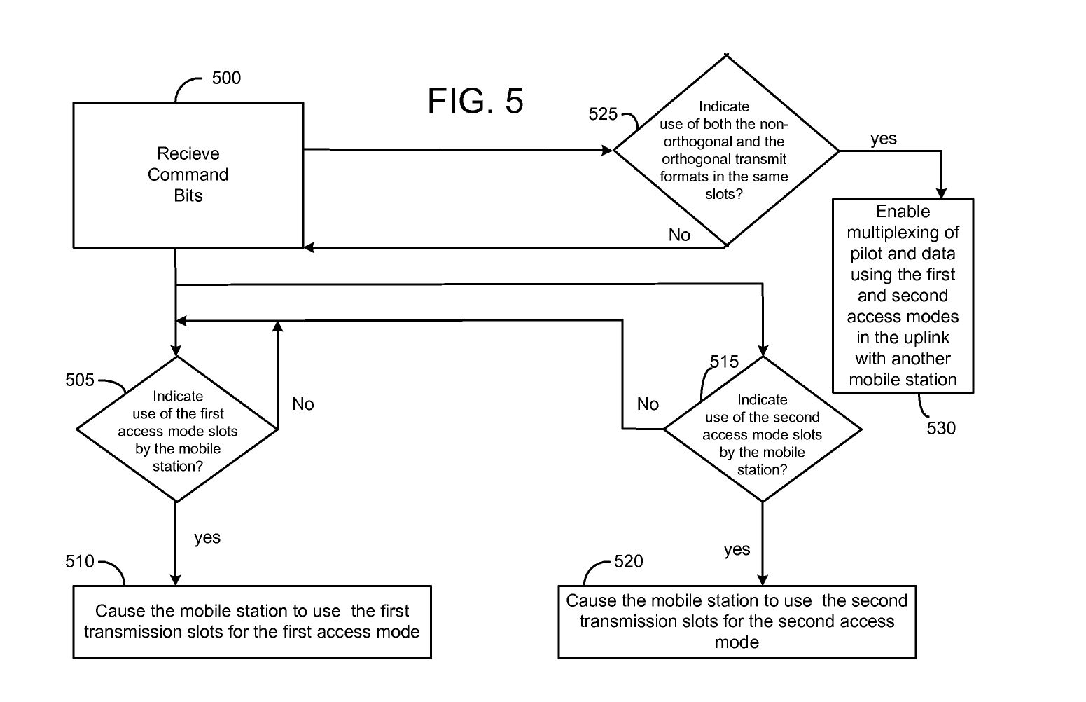

Finally referring to FIG. 5, a stylized representation for implementing a method of selectively using at least one of a first and a second access mode 165(1,2) is illustrated to multiplex a pilot and a data portion of the transmission 125 to provide a non-orthogonal or an orthogonal transmission in accordance with one illustrative embodiment of the present invention. At block 500, the mobile station 115(1) may receive command bits in the command 175 over the forward link (downlink) 140 from the base station sector 110(1). By using the command bits, the base station sector 110(1) may designate use of the first transmission slots for the first access mode 165(1) and the second transmission slots for the second access mode 165(2) to the mobile station 115(1).

A check at a decision block 505 may determine whether the mobile station 115(1) is indicated to use the first access mode 165(1) in the first transmission slots. If use of the first transmission slots is selected by the mobile station at the decision block 505, the transmitter 145 may cause the mobile station 115(1) to use the first transmission slots for the first access mode 165(1), at block 510. At block 515, a check at a decision block 515 may ascertain use of the second transmission slots for the second access mode 165(2). If the second access mode 165(2) is to be selected by the mobile station 115(1) responsive to the command bits received at block 500, the transmitter 145 may cause the mobile station 115(1) to use the second transmission slots for the second access mode 165(2), at block 520.

According to some embodiments of the present invention, one or more bits received within the command 175, at block 500, on the forward link (downlink) 140 may indicate use of both modes of the non-orthogonal and the orthogonal transmissions in the same slot. If use of both the modes, i.e., the first and second access modes 165(1,2) is indicated for the mobile station 115(1), at block 530, the transmitter 145 may enable multiplexing of the pilot and data using the first and second access modes 165(1,2) for the first and second formats 160(1,2), respectively.

In the uplink 120, however, time and frequency of code multiplexing may be applied to the same mobile station 115(1) or across another mobile station 115(m). The transmitter 145 may temporally separate the pilot and data portions of the first transmission 125(1) and the pilot and data portions of the second transmission 125(2) on the uplink 120. Using multi-carrier code division multiplexing for the first access mode 165(1) and time and frequency division multiplexing for the second access mode 165(2), either the same mobile station 115(1) or two mobile stations 115(1,m) may transmit the pilot and data portions in at least one of a time slot or a time sub-slot.

By selecting to transmit using the first access mode 165(1) in a MC-CDMA mode, the mobile station 115(1) may transmit control signaling in a first sub-slot, the pilot portion of the first transmission 125(1) in a second sub-slot, and the data portion of the first transmission 125(1) in a third sub-slot. To spectrally separate the pilot and data portions of the first transmission 125(1) and the pilot and data portions of the second transmission 125(2) in the uplink 120, the transmitter 145 may replace a time slot and/or a time sub-slot with a radio frequency channel and/or a sub-channel. This spectral separation may separate the first and second transmissions 125(1,2) in the frequency domain. Alternatively, the transmitter 145 may replace the time slot and/or the time sub-slot with a radio frequency tone and/or a sub-tone to separate the first and second transmissions 125(1,2) in the frequency domain. The transmitter 145 may instead spatially separate the pilot and data portions of the first transmission 125(1) and the pilot and data portions of the second transmission 125(2) in the uplink 120.

In one embodiment, the spread-spectrum cellular system 100 may wirelessly communicate mobile data at a speed and coverage desired by individual users or enterprises. According to one embodiment, the high-speed wireless data network may comprise one or more data networks, such as Internet Protocol (IP) network comprising the Internet and a public telephone system (PSTN). The 3rd generation (3G) mobile communication system, namely Universal Mobile Telecommunication System (UMTS) supports multimedia services according to 3rd Generation Partnership Project (3GPP) specifications. The UMTS also referred as Wideband Code Division Multiple Access (WCDMA) includes Core Networks (CN) that are packet switched networks, e.g., IP-based networks. Because of the merging of Internet and mobile applications, the UMTS users can access both telecommunications and Internet resources. To provide an end-to-end service to users, a UMTS network may deploy a UMTS bearer service layered architecture specified by Third Generation Project Partnership (3GPP) standard. The provision of the end-to-end service is conveyed over several networks and realized by the interaction of the protocol layers.

Portions of the present invention and corresponding detailed description are presented in terms of software, or algorithms and symbolic representations of operations on data bits within a computer memory. These descriptions and representations are the ones by which those of ordinary skill in the art effectively convey the substance of their work to others of ordinary skill in the art. An algorithm, as the term is used here, and as it is used generally, is conceived to be a self-consistent sequence of steps leading to a desired result. The steps are those requiring physical manipulations of physical quantities. Usually, though not necessarily, these quantities take the form of optical, electrical, or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise, or as is apparent from the discussion, terms such as “processing” or “computing” or “calculating” or “determining” or “displaying” or the like, refer to the action and processes of a computer system, or similar electronic computing device, that manipulates and transforms data represented as physical, electronic quantities within the computer system's registers and memories into other data similarly represented as physical quantities within the computer system memories or registers or other such information storage, transmission or display devices.

Note also that the software implemented aspects of the invention are typically encoded on some form of program storage medium or implemented over some type of transmission medium. The program storage medium may be magnetic (e.g. a floppy disk or a hard drive) or optical (e.g., a compact disk read only memory, or “CD ROM”), and may be read only or random access. Similarly, the transmission medium may be twisted wire pairs, coaxial cable, optical fiber, or some other suitable transmission medium known to the art. The invention is not limited by these aspects of any given implementation.

The present invention set forth above is described with reference to the attached figures. Various structures, systems and devices are schematically depicted in the drawings for purposes of explanation only and so as to not obscure the present invention with details that are well known to those skilled in the art. Nevertheless, the attached drawings are included to describe and explain illustrative examples of the present invention. The words and phrases used herein should be understood and interpreted to have a meaning consistent with the understanding of those words and phrases by those skilled in the relevant art. No special definition of a term or phrase, i.e., a definition that is different from the ordinary and customary meaning as understood by those skilled in the art, is intended to be implied by consistent usage of the term or phrase herein. To the extent that a term or phrase is intended to have a special meaning, i.e., a meaning other than that understood by skilled artisans, such a special definition will be expressly set forth in the specification in a definitional manner that directly and unequivocally provides the special definition for the term or phrase.

While the invention has been illustrated herein as being useful in a telecommunications network environment, it also has application in other connected environments. For example, two or more of the devices described above may be coupled together via device-to-device connections, such as by hard cabling, radio frequency signals (e.g., 802.11(a), 802.11(b), 802.11(g), Bluetooth, or the like), infrared coupling, telephone lines and modems, or the like. The present invention may have application in any environment where two or more users are interconnected and capable of communicating with one another.

Those skilled in the art will appreciate that the various system layers, routines, or modules illustrated in the various embodiments herein may be executable control units. The control units may include a microprocessor, a microcontroller, a digital signal processor, a processor card (including one or more microprocessors or controllers), or other control or computing devices as well as executable instructions contained within one or more storage devices. The storage devices may include one or more machine-readable storage media for storing data and instructions. The storage media may include different forms of memory including semiconductor memory devices such as dynamic or static random access memories (DRAMs or SRAMs), erasable and programmable read-only memories (EPROMs), electrically erasable and programmable read-only memories (EEPROMs) and flash memories; magnetic disks such as fixed, floppy, removable disks; other magnetic media including tape; and optical media such as compact disks (CDs) or digital video disks (DVDs). Instructions that make up the various software layers, routines, or modules in the various systems may be stored in respective storage devices. The instructions, when executed by a respective control unit, causes the corresponding system to perform programmed acts.

The particular embodiments disclosed above are illustrative only, as the invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular embodiments disclosed above may be altered or modified and all such variations are considered within the scope and spirit of the invention. Accordingly, the protection sought herein is as set forth in the claims below.

We claim:

1. A method of wireless communication between at least one mobile station and a base station sector in a cellular system, the method comprising:
enabling a first transmit format for a first transmission of said at least one mobile station to said base station sector to multiplex first and second components of said first transmission based on a first access mode; and
enabling a second transmit format different than said first transmit format for a second transmission from said at least one mobile station to multiplex first and second components of said second transmission based on a second access mode.

2. A method, as set forth in claim 1, further comprising:
selectively using at least one of said first access mode to multiplex a pilot and a data portion of said first transmission and said second access mode to multiplex a pilot and a data portion of said second transmission on an uplink; and
providing a non-orthogonal transmission based on said first transmit format and an orthogonal transmission based on said second transmit format.

3. A method, as set forth in claim 2, further comprising:
temporally separating said pilot and data portions of said first transmission and said pilot and data portions of said second transmission in said uplink.

4. A method, as set forth in claim 2, further comprising:
using multi-carrier code division multiplexing for said first access mode and time and frequency division multiplexing for said second access mode to transmit said pilot and data portions in at least one of a time slot or a time sub-slot.

5. A method, as set forth in claim 4, further comprising:
selecting to transmit in said first access mode based on a multi-carrier code division multiple access protocol; and
transmitting control signaling in a first sub-slot, said pilot portion of said first transmission in a second sub-slot, and said data portion of said first transmission in a third sub-slot.

6. A method, as set forth in claim 2, further comprising:
spectrally separating said pilot and data portions of said first transmission and said pilot and data portions of second transmission in said uplink.

7. A method, as set forth in claim 2, further comprising:
separating said first and second transmissions in the time domain.

8. A method, as set forth in claim 2, further comprising:
separating said first and second transmissions in the frequency domain.

9. A method, as set forth in claim 2, further comprising:
spatially separating said pilot and data portions of said first transmission and said pilot and data portions of second transmission in said uplink.

10. A method, as set forth in claim 4, further comprising:
selecting to transmit in said second access mode based on an orthogonal frequency division multiple access protocol; and
transmitting control signaling and one or more traffic symbols in a time slot for said second access mode.

11. A method of wireless communication between a base station and at least one mobile station in a cellular system, the method comprising:
assigning to said at least one mobile station one or more first transmission slots for use by a first access mode that enables a non-orthogonal transmit format and one or more second transmission slots for use by a second access mode that enables an orthogonal transmit format.

12. A method, as set forth in claim 12, wherein assigning to said at least one mobile station further comprises:
providing a command in a downlink to assign said one or more first and second transmission slots for transmitting data from said at least one mobile station on an uplink to said base station.

13. A method, as set forth in claim 13, further comprising:
indicating use of each of said one or more first transmission slots for said first access mode; and
indicating use of each of said one or more second transmission slots for said second access mode.

14. A method, as set forth in claim 11, further comprising:
indicating use of said orthogonal and non-orthogonal transmit formats in said one or more first transmission slots.

15. A method, as set forth in claim 11, further comprising:
indicating use of said orthogonal and non-orthogonal transmit formats in said one or more second transmission slots.

16. A method, as set forth in claim 11, further comprising:
determining whether said at least mobile station is using said first or second access modes; and
if use of said first access mode is indicated, receiving control signaling in a first sub-slot, a pilot portion and a data portion in a second sub-slot.

17. A method, as set forth in claim 16, further comprising:
if said at least one mobile station indicates that said second access mode is selected, receiving control signaling and one or more traffic symbols in an entire time slot.

18. A method, as set forth in claim 11, further comprising:
multiplexing use of said first and second access modes for populating said first and second transmission slots on an uplink.

19. A method, as set forth in claim 11, further comprising:
defining a criterion for said at least one mobile station such that the interference from said first and second access modes at said base station remains below a given threshold; and
causing said at least one mobile station to select one transmit format between said orthogonal and non-orthogonal transmit formats based on said criterion.

20. A method, as set forth in claim 11, further comprising:
multiplexing a first transmission based on said first or second access modes for an uplink to said base station from said at least one mobile station with a second transmission based on said first or second access modes from another mobile station.

21. A frame format for enabling a wireless communication between at least one mobile station and a base station sector in a cellular system, the frame format comprising:
a first transmit format for a first transmission of said at least one mobile station on an uplink to said base station sector to multiplex said first transmission based on a first access mode; and
a second transmit format different than said first transmit format for a second transmission on said uplink from said at least one mobile station to multiplex said second transmission based on a second access mode.

22. A frame format, as set forth in claim 21, further comprising:
a pilot and a data portion of said first transmission, said pilot and data portions multiplexed using said first access mode to provide a non-orthogonal transmission based on said first transmit format and an orthogonal transmission based on said second transmit format on said uplink.

23. A frame format, as set forth in claim 22, further comprising:
a pilot and a data portion of said second transmission, said pilot and data portions multiplexed using said second access mode to provide a non-orthogonal transmission based on said first transmit format and an orthogonal transmission based on said second transmit format on said uplink.

24. A frame format, as set forth in claim 23, further comprising:
a time slot to transmit said pilot and data portions based on multi-carrier code division multiplexing for said first access mode and time and frequency division multiplexing for said second access mode, wherein said pilot and data portions of said first transmission and said pilot and data portions of said second transmission are separated in one of a group of temporal, spectral, and spatial domains in said uplink.

25. A frame format, as set forth in claim 23, further comprising:
a time sub-slot to transmit said pilot and data portions based on multi-carrier code division multiplexing for said first access mode and time and frequency division multiplexing for said second access mode, wherein said pilot and data portions of said first transmission and said pilot and data portions of second transmission are separated in one of a group of temporal, spectral, and spatial domains in said uplink.
